(19) United States
(12) Patent Application Publication
(10) Pub. No.: US 2007/0131505 A1
(43) Pub. Date: Jun. 14, 2007

(54) Magnetic Induction Charging System for Vehicles

(76) Inventor: Bryan Hyung Joong Kim, Charleston, WV (US)

Correspondence Address: Bryan Kim, 310 Grandview Pointe, Dunbar, WV, 25064, US

(21) Appl. No.: 11/456,917

(22) Filed: Jul. 12, 2006

Related U.S. Application Data
(60) Provisional application No. 60/700,108, filed on Jul. 16, 2005.

(51) Int. Cl. B60M 1/00

(52) U.S. Cl. 191/14

(57) ABSTRACT

A novel system for easily aligning a ground mounted power supplying electromagnetic inductor to a vehicle mounted power absorbing electromagnetic inductor is presented. The power supply inductor is preferably mounted within a parking block or a speed bump. The power absorbing inductor is mounted in a vehicle, preferably between the front tire and the front bumper. When the vehicle's front tires touch the parking block or the speed bump, the two electromagnetic inductors are aligned sufficiently to transfer power efficiently.

### BACKGROUND—CROSS-REFERENCE TO RELATED APPLICATIONS

This invention is entitled to the benefit of Provisional Patent Application APPL No. 60/700,018 filed Jul. 16, 2005.

### BACKGROUND

Recently, a type of vehicle propulsion technology that combines the traditional internal combustion engine with an auxiliary electrical propulsion system has been gaining worldwide popularity. Such a “hybrid propulsion” is actually an old technology, dating back to the submarines of World War I era, in which diesel engines were used to charge a battery as well as propel the vessel on the surface. The provision of the secondary electrical propulsion system meant that the diesel engines did not have to be used to propel the vessel at all times, particularly when the vessel was submerged. In some cases, the electrical propulsion system was powerful enough to attain burst speeds comparable with speeds attainable under diesel propulsion.

Electric cars are even older, with successful examples and suitable batteries being demonstrated by Thomas Edison. And in this age of energy and environmental concerns, there continues to be an interest in being able to propel vehicles without the use of an internal combustion engine. During the late 1990's, California had experimented with all electric vehicles. As expected, the very short range of the electric vehicles, about 70 miles or so on a full charge, made such a vehicle an impractical tool for most drivers. Furthermore, the hours of charging time needed by the batteries precluded quick recharges at rest stops. Finally, most drivers seems to find the act of connecting their vehicle to the power supply inconvenient. In fact, forgetting to do so one evening could render the vehicle useless for the next morning's commute.

While some internal combustion engines have also become extremely clean, a desire to minimize their use remains. There is also a constant desire to minimize petroleum consumption. Thus, the old submarine propulsion technology has found a new niche in vehicles propulsion, as a low power propulsion system. Unlike all electric vehicles, the battery of a current generation hybrid vehicle is charged by the vehicle's internal combustion engine. Thus, all of the energy needed for propulsion is still provided by the fuel supplied to the internal combustion engines. The niche for the hybrid propulsion system arises from the fact that most vehicles have engines sized for necessary acceleration performance rather than cruise. Typically, an internal combustion engine is three times larger than that needed for cruise at street legal speeds. In a hybrid propulsion scheme, the internal combustion engine can be smaller, since the electric traction motor can provide a part of the low speed acceleration. Furthermore, the torque characteristics of an electric traction motor is perfectly suited for acceleration from standstill. As a result, even a small electrical motor is capable of providing a much more forceful acceleration than their power ratings would suggest. The fact that traction motors can also provide regenerative braking in the traditional manner of electric trains is also useful.

In addition to the smaller sized engine, the hybrid propulsion system can eliminate the idling of the engine altogether. Of course, idling and other low throttle operations of the engine are extremely inefficient, since all of the engine power is absorbed by the internal drag of the engine itself without providing any useful work for the vehicle. In a hybrid vehicle, this mode of operation is completely eliminated, since the engine can be shut off altogether during very low speed operations, or be used at a greater throttle opening to charge the batteries.

On the other hand, the weight of the battery remains a disadvantage, since all of the energy for the electrical propulsion system comes from the internal combustion engine. Thus, the rational design paradigm is to provide the smallest and lightest electrical propulsion subsystem that provides a useful benefit. Indeed, this is precisely how the current generation of hybrid vehicles are designed. A typical hybrid vehicle is equipped with an internal combustion engine of 90 HP class, and an electrical battery of 25 HP class, able to provide 25 HP to a traction motor for low speed acceleration. While there is a very tangible benefit to this scheme in terms of fuel economy, the internal combustion engine is still much larger than needed for cruise. However, there is not much incentive to reduce the size of the internal combustion engine further, because that reduction would have to be accompanied by an enlargement of the electrical propulsion system power output. In turn, that would require a correspondingly heavier storage battery. A much larger battery would largely negate the economy gains provided by switching to a smaller internal combustion engine.

This design paradigm for hybrid vehicles changes greatly if the battery can be charged from an external power source while parked. If the energy content of a depleted battery can be replenished from an external electrical power generated from non petroleum sources, much of the vehicle's daily energy consumption would be met from these non petroleum sources. For example, even if the electrical energy content of the vehicle was sufficient only for 30 miles, that still constitutes a very large portion of a daily commute.

In fact, such retrofit kits for hybrid vehicles are commercially available now. They provide a cable and a plug, as well as needed electrical conditioning apparatus, for supplying electrical energy from an external power source to a depleted battery. However, having to connect the vehicle to an electrical power source manually every time the vehicle is parked makes such a scheme as cumbersome as that for electrical vehicles. Many or most drivers would find it very inconvenient to recharge their vehicles, and simply operate with the internal combustion engine without ever recharging the battery from an external power source.

If some guarantee can be made that the drivers would be very diligent in recharging their hybrid vehicles, a typical car can be designed around a 50 HP class internal combustion engine and a 75 to 100 HP class battery. The 50 HP class engine is enough to provide cruise at street legal speeds, and the torque of the electric traction motor would provide a very adequate acceleration and cruise without the use of the internal combustion engine. Such a large battery would hold enough energy to propel the vehicle for most of the daily drive before the internal combustion engine would have to be engaged. And on long distance road trips, they would still have the long range and quick refueling capabilities of a conventional internal combustion engine propulsion system. Such a scheme would drastically shift the energy consumption of the vehicle away from petroleum based fuels, without sacrificing any capabilities of current cars. Thus, what is needed to make a large battery hybrid vehicle commercially viable is a way of guaranteeing that the driver will recharge the vehicle from an external source every time he parks, regardless of weather or other inconveniences.

The safest method of transferring electrical energy from an external power source to a vehicle is through a magnetic induction coupling scheme. Such a scheme permits power transfer without any possibility of a person coming in contact with live or wet electrical power outlets. The idea of supplying electrical power to road vehicles from roadways through magnetic induction is as old as the use of alternating current. In 1891, Shover and Dickson revealed one of earliest such ideas in their U.S. Pat. No. 461,057, which is a scheme for supplying power to an electric rail car, which is typically powered by bare electrical contacts, even now. The greatest advantage touted by Shover and Dickson was the safety of magnetic induction power transfer compared to direct electrical contact power transfer. Magnetic field does not transfer energy into nonconductors like people, which makes it safe to use powerful magnetic fields for medical imaging purposes or powering artificial hearts.

In U.S. Pat. No. 874,411, Leblanc shows a different arrangement of inductive power transfer, again to a moving vehicle. He points out the advantages of using high frequency alternating current to minimize energy transfer to nearby conductors. He also describes a secondary battery that is capable of driving automobiles on roads not equipped with magnetic induction power sources. In, U.S. Pat. Nos. 3,914,562 and 4,007,817, Bolger discloses his way of embedding the inductive power transmitter in roads, as well as a way of reducing the air gap between the embedded power transmitter and the vehicle mounted power receiver. His scheme raises and lowers the power receiver as needed. In U.S. Pat. No. 4,331,225, Bolger discloses his method of automatically controlling the air gap between the power receiving element and the power supply embedded on the roads. On, U.S. Pat. No. 5,311,973, Tseng shows a method of managing the supply of electrical power to the roads that are equipped to generate magnetic fields for inductive power transfer to moving vehicles. He also expresses his preference that the entire vehicle should wrapped in wire to maximize the inductive coupling between the road and the vehicle, and elaborates on the concept further on U.S. Pat. No. 5,431,264.

The topic of maintaining the alignment of the power supply coils mounted in roads and the power receiving elements mounted on vehicles also received attention. In U.S. Pat. No. 5,595,271, Tseng shows one way of aligning the power receiving element both vertically and laterally to maximize the inductive coupling between the power transmitter and receiver. In U.S. Pat. No. 5,595,271, Ross shows his preferred method of transferring inductive power from the road to the vehicle, as well as his method of managing the flow of electricity within the vehicle. Specifically, he points out the fact that vehicles spend much of their time in stationary parking. Accordingly, he mentions that the movable power receiving element can be lowered to be in physical contact with the ground mounted power supply for essentially lossless power transfer in the same manner as a transformer does.

In all of these patents, the intended power sources for the vehicles were road mounted, and were to transmit power to the vehicle while the vehicles were in motion. Thus, the alignment mechanism for the power absorbing coils were necessarily complex, since a vehicle in motion is invariably in slight but constant lateral motion, which is corrected by continuous corrective actions of the vehicle steering. None of them is optimized for the role of charging a vehicle that is stationary. And for the needs of an all electric vehicle, the inherently low energy content to weight ratio of power storage batteries means that the electrical energy content stored on board batteries can only propel the vehicle for a some tens of miles unless a battery of excessive weight is used. Of course, such a battery would be self defeating, since excessive battery weight would reduce the useful load of the vehicle.

The popular acceptance of hybrid vehicles changes that situation drastically, since the internal combustion engine handles the long distance cruise very effectively. What is needed is the simplest method of efficiently coupling the vehicle to an external power supply through electromagnetic induction. And as had been pointed out in prior art patents, the all important parameter for efficient coupling of magnetic induction is the alignment of the power receiving inductor with the magnetic field generated by the power supply inductor. On the other hand, the complexity and the expense of schemes proposed by aforementioned patents are hardly necessary for chargers that will only operate only while the vehicle is parked. What is truly needed is a simple system that enables a driver to align the vehicle effectively to the magnetic inductor without complex automatic controls.

Some simple and very effective devices that cause drivers to align their vehicles to specified locations are in use. The simplest method for guiding drivers to align their vehicles is a painted line. Obviously, virtually all driving requires drivers to keep their vehicle between painted lines on the road, so any licensed driver is practiced in this skill. All parking lots constitute flat surfaces with painted lines, and for the most part, drivers align their vehicle very well to the lines with little effort. The second aid that is also successful is a parking block located at the edge of the parking spot that stops the forward movement of the vehicle. When such blocks are present, all drivers can perfectly align their wheels to the parking block.

### BACKGROUND OF INVENTION—OBJECTS AND ADVANTAGES

Some of the objects and the advantages of this invention are:
(a) to provide a simple mechanism for transferring electrical power from a ground mounted source to a stationary vehicle via magnetic induction.
(b) to provide a simple ground mounted power source that is safe under all situations.
(c) to provide a method for aligning the vehicle mounted and the ground mounted components of the power transfer system by a driver of minimal skill and experience.
(d) to provide a simple vehicle mounted power absorbing unit that is capable of charging an on board electrical power storage device and providing electricity to vehicle systems.

Further objects and advantages will become apparent from consideration of ensuing descriptions and drawings.

### SUMMARY

The invention is the transfer of electric power into a stationary vehicle from an external source through magnetic induction. It consists of a magnetic induction power transmitter that is powered by an external source, housed in an enclosure that assists in the aligning of the vehicle with the charger in the longitudinal and lateral directions. Parking blocks and speed bumps make for ideal enclosures for the charger. The magnetic induction power receiver is mounted aboard the vehicle on variable height suspension that permits it to be lowered to reach down to the upper surface of the power transmitter.

### DRAWINGS

FIG. 1 is a schematic layout of a typical magnetic induction arrangement as found in electrical transformers.

FIG. 2 is a schematic of how a typical transformer type inductor can be divided into two halves to create an inductive charger for transferring electrical power to a vehicle.

FIG. 3 is a schematic of how the ground mounted power supply portion of the inductive charger can be encased in a parking block that limits the longitudinal motion of the vehicle.

FIG. 4 is a schematic of how a ground mounted power supply portion of the inductive charger can be encased in a speed bump that permits slow longitudinal motion of the vehicle over it.

FIG. 5 is a schematic of an inductive charger whose vehicle mounted power absorbing member can be lifted or lowered, which is shown in the lifted position.

FIG. 6 is a schematic of an inductive charger whose vehicle mounted power absorbing member can be lifted or lowered, which is shown in the lowered position.

FIG. 7 is a schematic of an inductive charger whose coils form an approximate toroid, shown with a proximity switch for energizing the power supply coil, and with components for interrogating the identity of the vehicle drawing electrical power.

FIG. 8 is a schematic of a magnetic induction charger whose electromagnetic power transfer components can traverse laterally to assist in lateral alignment.

FIG. 9 is the same device as FIG. 8, whose movable electromagnetic components have shifted to the left side.

### DESCRIPTION

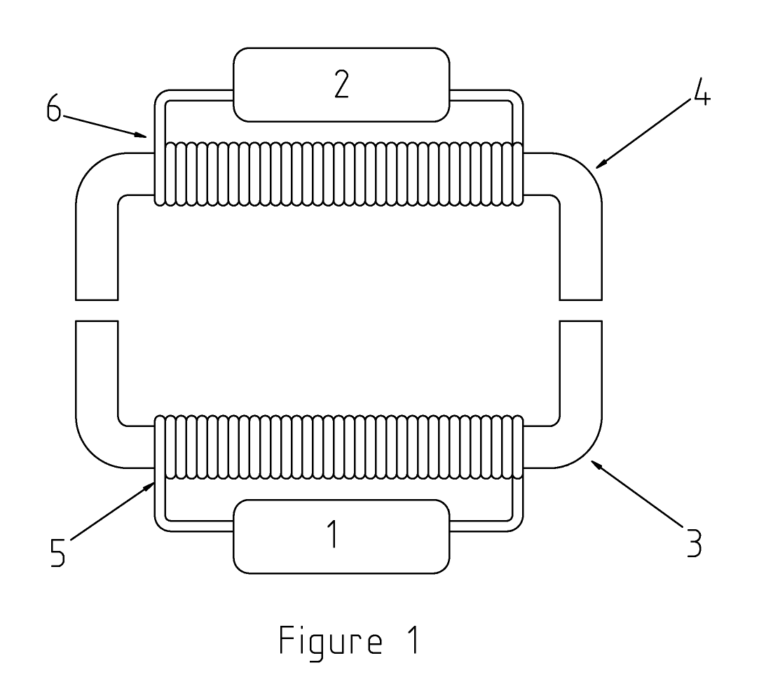

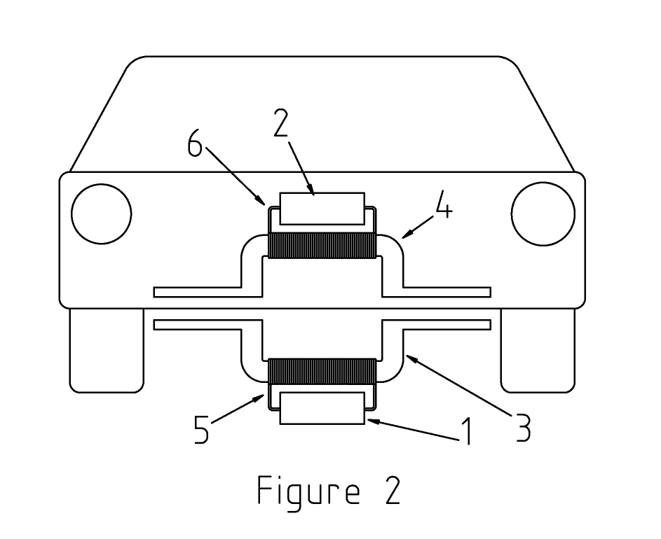

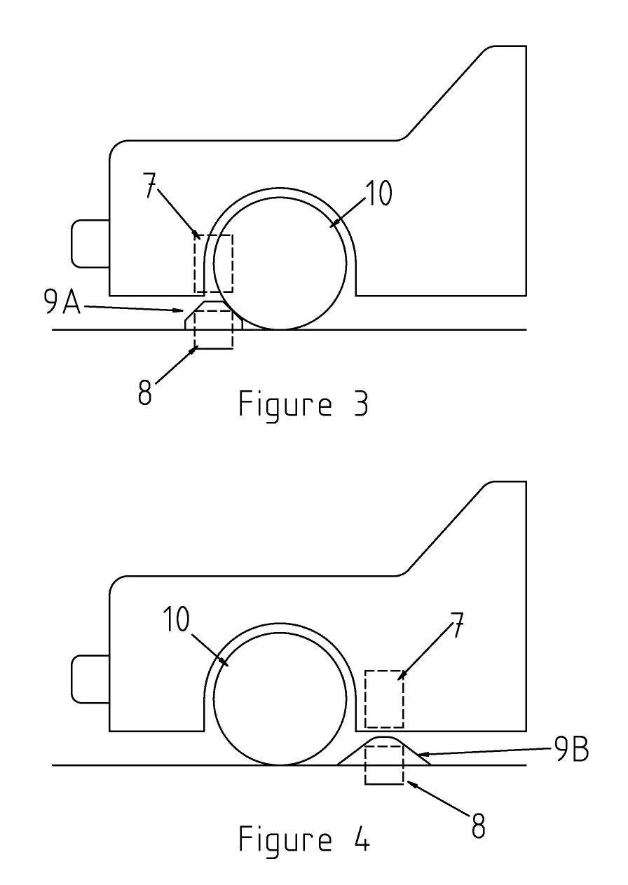

A preferred embodiment is shown as FIGS. 3 through 7. FIGS. 1 and 2 display the core energy transfer components that would be present in any implementation of this invention in greater clarity than can be shown in subsequent figures.

FIG. 1 shows the core energy transfer element of this invention. The power source 1 represents an alternating current supply. This alternating current supply 1 is connected to the coil 5, which is wrapped around a ferrous core 3. The elements 1, 3 and 5 constitute the core functional components of the power transmitter described in the rest of this document. An alternating current load 2 is connected to a coil 6, which is wrapped around a ferrous core 4. Elements 2, 4, and 6 constitute the core functional components of the power receiving element of this invention. The load 2 will almost always include a rectifier to turn the alternating current into a direct current. When the power transmitter and receiver of this invention are operating, the core elements are aligned as shown in FIG. 1.

FIG. 2 shows the elements shown in FIG. 1 in the context of a vehicle. The vehicle mounted portion of this invention, 2, 4, and 6, are shown within the envelop of the vehicle. In this view, the ferrous cores 3 and 4 are shown with elongated arms that traverse a greater portion of the vehicle's width. This is the preferred orientation of the ferrous core elements 3 and 4 in this invention. The ferrous core elements should be mounted such that the magnetic field between the two poles of the coil are perpendicular to the length of the vehicle, with the magnetic poles on either side of the centerline of the vehicle. Orienting the magnetic poles longitudinally does not affect the power transfer functionality of this invention, and may be used in special circumstances. However, much work had been done on road mounted magnetic induction power transmitters, which prefer a magnetic power supply whose poles are on either side of the centerline of the road, spanning the width of the road. Expecting the possible future advent of such specialized roads, the preferred embodiments of this invention would lay out their electromagnetic elements such that the magnetic poles are to either side of the vehicle's centerline.

In FIGS. 3 and 4, the block 7 represents the assembly of the power receiving elements, which were shown as 2, 4, and 6 in previous figures. Block 8 represents the assembly of power transmitter elements, which were shown as 1, 3, and 5 in previous figures. These figures show preferred enclosures for the power transmitter 8. FIG. 3 shows it enclosed in a typical parking block 9A, as found in many public parking lots in which the vehicles are parked side by side. Such a parking block should be sturdily mounted to the ground in such a way as to prohibit the forward motion of the vehicle past it, in the manner of the usual parking blocks. For the purposes of power transmission, there is no difference as to where this receiver is located as long as it is at the bottom of the vehicle. Practically, the power receiver 7 is shown as being outside the wheelbase of the vehicle, behind and below the front bumper. This would make it easy for most drivers to align the power receiver and the power supply.

FIG. 4 shows the power transmitter 8 enclosed in a speed bump 9B. Like the parking block, the speed bump enclosure should be sturdily mounted on the ground in the manner of traditional speed bumps. However, unlike the parking block, the speed bump should permit a slow motion of the vehicle past it. By permitting the vehicles to move past it slowly, such installations can be used on streets designated for parallel parking. The power receiver 7 is shown as being within the wheelbase of the vehicle, to emphasize the fact that the use of a speed bump type enclosure for the transmitter permits the vehicle to traverse the transmitter.

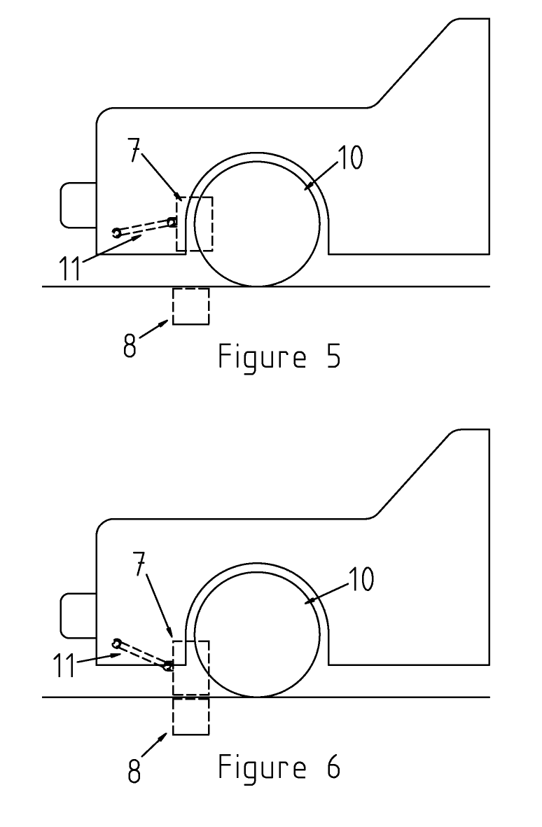

FIGS. 5 and 6 show the preferred mounting scheme for the power receiver 7. They show a swinging pivot arm suspension 11 that connects the power receiver 7 to the vehicle. Any other lifting mechanism that is capable of positioning the receiver 7 at a specific distance from the ground is also suitable. A hydraulic or pneumatic piston, electromechanical servo, electrostatic linear actuator, or any number of other suitable devices are available commercially, and there is no preferred lifting mechanism. Notably, it can be a mechanical linkage connected by means of levers to the parking break of the vehicle so that actuating the parking break mechanically lowers the power receiver. The various suspension mechanisms can be fitted with a spring element that bears the weight of the charger, in the same manner as the springs of an automotive suspension bearing the weight of the automobile.

The swing arm 11 is shown here for ease of conceptual illustration. By enabling the bottom of the receiver to be positioned at a variable distance from the ground, the different power transmitter mountings can be used effectively. FIG. 5 shows the receiver in the raised position, which would be how it would be stowed while the vehicle was in motion. FIG. 6 shows the receiver 7 in its lowered position, positioned over the ground mounted power transmitter 8 whose top is flush with the ground. Obviously, the position of receiver 7 can be adjusted to reach a raised speed bump or parking block.

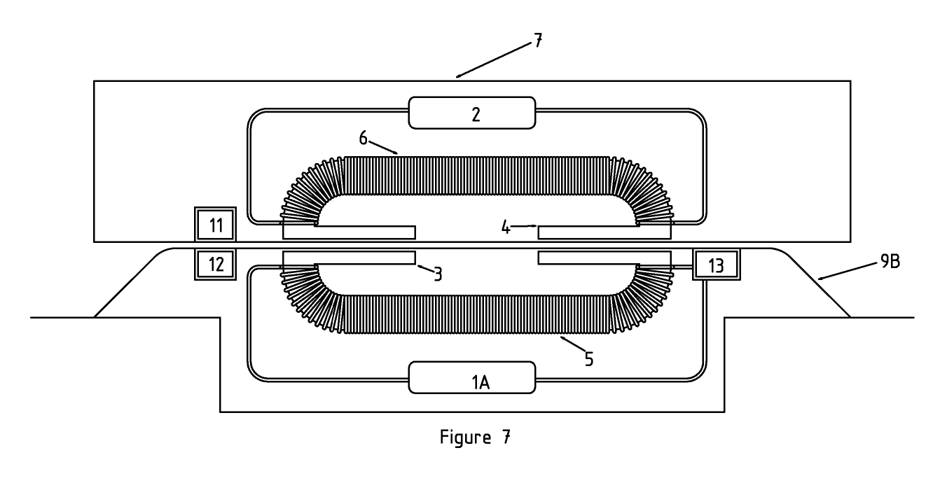

FIG. 7 shows the major components of this invention in detail. Power receiver 7 is shown with the preferred types of components. The most important feature shown in this Figure is the exact configuration of the coil 6 and the ferrous core 4. The coil is shown as being wrapped around the ferrous core to form a half toroid. Likewise, the power supply coil 5 and the ferrous core 3 form a half toroid. When the power receiver is properly positioned over the power supply, the coils 5 and 6 should be in a toroidal configuration, as shown in FIG. 7. The ferrous core elements 3 and 4 are shown with inwardly extending arms that increase the cross sectional area of the ferrous core elements 3 and 4 at the interface of the transmitter and the receiver.

The power transmitter enclosed in a speed bump 9B of FIG. 7 encloses the following major components aside from the coil 5 and the ferrous core 3: an alternating current power supply 1A, vehicle proximity sensing switch 13, and vehicle identity interrogator 12. The coil 5 is electrically connected to an alternating current power supply 1A. This power supply 1A denotes any power supply that delivers electrical power to the vehicle at the frequency required by the vehicle. In the special case of the vehicle being able to accept 50/60 Hz municipal power grid frequency, this power supply will be a simple, direct electrical connection to the municipal power grid.

A proximity switch 13 is positioned in the speed bump so that it can detect the presence of the power receiver 7. Its function is to cut off the electrical power to the coil 5 when the power receiver 7 is not present. Many possible detectors are available commercially. They range in complexity from ranging lasers and radars to simple push button switches that close a circuit when physically pushed. There is no particular preference for any given type of proximity switch as far as the performance is concerned. Clearly, a physical push button that interrupts the circuit between power supply 1A and coil 5 is an effective solution. Optionally, this switch can include a load testing mechanism for the coil 5, such that upon being activated, it would measure the current flow in the circuit so as to determine if there is a real inductive load to above the power transmitter. If there is no inductive load, the switch can shut off the power to the coil until it is released and actuated again.

Vehicle identity interrogator 12 is positioned opposite the vehicle identity transmitter 11. Such identity transmitters that broadcast low power encoded identity signal are commercially available and in widespread use by industries whose billing requires reading various meters that measure the use of gas or electricity. Such devices obviously transmit much more information than just the identity of the receiver, so a higher bandwidth data link between the vehicle and the ground mounted power transmitter are possible with existing commercially available components. Indeed, the spread of secure wireless Internet connection technologies have resulted in suitable protocols and components that can be used in this invention for vehicle identification purposes. Of course, if a wide bandwidth connection is used, a greater data transfer capability far beyond vehicle identification purposes may be useful for other purposes. Devices that transmit just the identity are simpler and smaller, and very small versions are even available for implanting beneath human skin. Such identity interrogation chips are invariably matched to the suitable interrogator, which are also commercially available.

The vehicle identity set 11 and 12 are only necessary for installations where the cost of the electricity transmitted to the vehicle has to be billed the particular vehicle. Clearly, in one's personal garage, such devices would not be necessary.

Other options besides the commercially available identity chips are usable. For example, the identity transmitter can be a simple optical pattern, and 12 can be a digital camera. In such a scheme, the image generated by a digital camera is recognized by a computer with a suitable algorithm. Such systems have been commercially available for years. A particularly wide spread form of this technology is a commercial bar code reader. However, in most cases, the bottom of the charger will not be very clean. Grease, mud, and whatever else is splashed from the road onto the bottom of the vehicle will coat the bottom of the power receiver, unless the power receiver is enclosed in a protective sheath when not in use. Magnetic field has no trouble penetrating such coated matter, and it is desirable to use a vehicle identification system that can also penetrate such coated matter. Identity transmitter/receiver schemes that use electromagnetic wavelengths that can penetrate some dielectric material are desirable for this application.

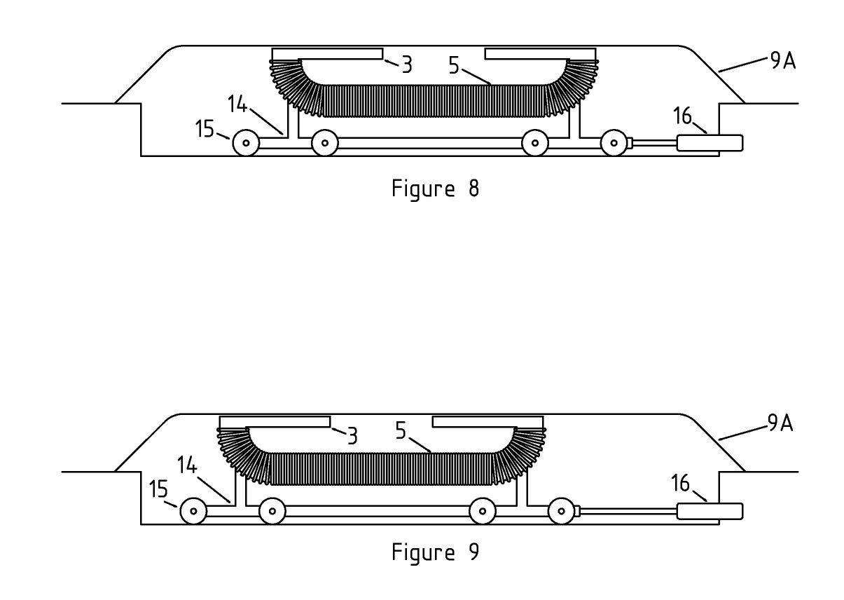

FIGS. 8 and 9 show an optional feature of the power transmitter. When encased in a typical power block or speed bump enclosure 9B as shown, the width of the enclosure is far greater than the width of the enclosed power transmitting coil 5 and its ferrous core 3. This permits the electromagnet assembly to be mounted on a rolling truck 14, which is attached to the ground by means of wheels 15. The truck will be able to slide sideways, without permitting any vertical motion. FIG. 8 shows the truck in the centered position, while FIG. 9 shows it having slided to one side. The other elements such as the power supply 1 or the various switches are omitted for clarity in these figures. Optionally, this truck can be attached to a position actuator 16. Actuator 16 is meant to show a sliding assembly in these figures, but any number of devices are available to actuate the one dimensional motion of the truck 14, such as servomotors, electrostatic actuators, etc. There is no particular preference for any type of actuator, except for the motive power being electrical in nature.

Clearly, if the power transmitter housing is to permit its electromagnetic power transmission elements to slide, inside has to be hollow to give the elements room to slide. It goes without saying that the enclosure has to be sturdy enough to bear whatever weight might be imposed upon it sustaining any damage.

### Reference Numbers

1 Alternating current power supply.
1A Alternating current power supply whose frequency is matched to the special frequency required by the vehicle.
2 Alternating current load.
3 Ferromagnetic element of the power supplying electromagnet.
4 Ferromagnetic element of the power absorbing electromagnet.
5 Coil element of the power supplying electromagnet.
6 Coil element of the power absorbing electromagnet.
7 Vehicle mounted power receiving unit.
8 Ground mounted power supply unit.
9A Power supply unit shell configured as a parking block.
9B Power supply unit shell configured as a speed bump.
10 Vehicle tire/wheel.
11 Vehicle identity transmitter.
12 Vehicle identity interrogator.
13 Proximity switch.
14 Sliding truck.
15 Truck roller.
16 Linear actuator.

### Operation

Magnetic induction is a well understood principle, and all voltage transformers operate on this principle. FIG. 1 shows the core energy transfer components of this invention, and it should be obvious to anyone with a knowledge of transformers that this is a transformer whose ferrous core has been divided in half. since magnetic field does not need a ferrous core to traverse macroscopic distances, the power transfer can take place effectively even if there is a little gap between ferrous cores 3 and 4.

The operation of these components is identical to that of a transformer. The alternating current source 1 supplies electrical power to coil 5. In turn, the coil 5 turns the alternating current into an oscillating magnetic field. The magnetic field is mostly contained in the ferrous core 3, which provides a directed pathway for the field. The magnetic field jumps the gap between the ferrous core elements 3 and 4. In turn, coil 6 turns the oscillating magnetic field within the ferrous core 4 back into alternating current, which is absorbed by the load 2. In most cases, most or all of the load 2 will be a rectifier that turns the alternating current into direct current. The vehicles' batteries are chemical energy storage devices, so they are intrinsically direct current devices. Charging them requires direct current, so a rectifier is necessary.

The voltage relationship between that supplied to 1 and that extracted by 2 depends on the number of winding of coils 5 and 6, as is well known in the art of transformer design. Normally, these will require greater power than the household electronics. The maximum power that the power supply 1 has to deliver will be dictated by the amount of power that the battery can absorb. This tends to be on the same order of magnitude as the amount of power that the battery can deliver, so a 50 KW class battery will be able to absorb on the order of 50 KW, which makes this a far more demanding load than most household items. While a typical 110 or 220 class household power supply voltage can certainly be used, many users will prefer installing higher voltage connections as dedicated power supplies, since existing household power wiring will be completely inadequate for this task. Otherwise, power supply 1 has to contain a current limiting scheme, which is easy enough to implement, but reducing the rate of power delivery to the battery increases the charging time.

Chargers for rechargeable batteries are very common, since most portable electronic devices use rechargeable batteries. The chargers for such batteries invariably include a transformer. In practice, the coils 5 and 6 would be designed to function as that transformer. Thus, this invention will not increase the number of components that would be needed for a conventional charger that simply provides a cable connection to the municipal power supply through a plug.

Magnetic field energy is essentially unabsorbed by dielectric material that does not possess a conduction band in its electronic structure. And most of the dirt, mud, salt and grease present on the road are dielectric materials. Although the ionic dissociation of dissolved salt elements can absorb a slight amount of magnetic field energy, the magnitude of energy loss to such absorption will be negligible.

One issue of potential concern mentioned in previous literature is the effect of magnetic field in human bodies. It should be noted here that there is absolutely no evidence that magnetic field is harmful to humans. In fact, magnetic resonance imaging devices using far more powerful magnetic fields than would be present in this invention are used for medical purposes. Even more powerful fields have been used on small animals in levitating experiments, without any apparent harm to the animals. Having stated such, there seems to be an implicit consent that minimizing the magnetic fields outside of the ferrous cores 3 and 4 is desirable.

One method for limiting the spacial extent of the magnetic field is to change the frequency of the alternating current so that a the magnetic field would be of a different (higher) frequency than that of the municipal power grid. This invention is not tied to any particular frequency of the alternating current or magnetic field oscillation, so it suffices to mention here that alternating current power supply 1 can be of a different frequency than the municipal power grid frequency. Very high power devices that shift alternating current to higher frequencies are commercially available. Among other devices, ultrasonic equipment tends to operate in the kilohertz to megahertz range, and often require a lot of power, and ultrasonic power generators would be suitable as the power supply for this invention if a higher frequency is desired.

Another, more relevant method of minimizing magnetic field leakage is to form a so called toroidal coil. Such coils are widely used in electronic devices in which leakage of magnetic field might interfere with operation of other components. FIG. 7 shows such a configuration of coils for this invention. Wrapping the ferrous core elements in coil to the greatest extent possible, and leaving little of the ferrous coil exposed except for pole surfaces, are easy to do, and maximize the magnetic inductance for the given size of the components. When the poles of the power transmitter and receiver electromagnets are aligned, the whole assembly resembles a toroidal coil, and will contain the magnetic field effectively. The little bit of the magnetic field that leaks out will be absorbed by the free electrons of the massive steel and metal structures of the vehicle, which will serve as very effective shields for magnetic fields.

FIG. 2 shows the major power transfer elements of this invention in their desired orientations with respect to the frontal view of the vehicle. In fact, it should be obvious that the orientation of the electromagnetic elements for a vehicle that is parked does not affect the power transfer efficacy of the system. However, if an electromagnetic induction power is ever built into a roadway, it will have to be oriented such that the magnetic fields stretches from one side of the lane to the other. Certainly, the vast majority of electromagnetic induction power supply schemes that embed the power transmitter into the road use such a layout.

Aligning the power receiver to a static power transmitter requires positioning the receiver in three dimensions: lateral, longitudinal, and vertical. For the purposes of this invention, the layout shown in FIG. 2 is also advantageous. The ferrous cores of the electromagnetic elements 3 and 4 are shown with extended arms that increase the extent of the overlapping cross section between the transmitter and receiver elements. Even if there is minor misalignment on the order of tens of centimeters between the transmitter and the receiver elements, there will still be very effective inductive coupling because of the extended arms providing additional cross sectional area. The lateral orientation of the electromagnetic elements and the extended arms make the lateral alignment very easy. Practically, every driver is tested on being able to park onto a typical parking spot of a public parking lot without undue effort before a driver's license is ever granted. Thus, no driver will find it cumbersome to park the vehicle within tens of centimeters of a designated lateral coordinate.

The next dimension of alignment is the longitudinal. Aligning the vehicle in this dimension is a little more challenging. Accelerator and brakes that are used to control longitudinal motion are much less precise than the steering wheel used to control the lateral positioning. Thus, longitudinal positioning aids are in common use in parking lots, namely in the form of parking blocks. All a driver has to do is drive his vehicle slowly towards a parking block until the wheels touch the block, and he is perfectly positioned in the longitudinal coordinate within the parking spot. The important trait here is that the vehicle touches the parking block at the same position every time. And this point of contact is the ideal reference point for locating the power supplying inductor and the power absorbing inductor. In principle, locating the two inductors at the same distance from the point of contact will cause the two to be aligned when the vehicle makes contact with the block.

The most advantageous location for the inductors will be to place the power source inductor within the parking block itself. Embedding the magnetic induction power transmitter within a parking block will make the longitudinal alignment of the transmitter and the receiver trivially easy for the driver. FIG. 3 shows such an arrangement. The power transmitter 8 is housed in a parking block enclosure 9A that prohibits further forward progress of the vehicle. The vehicle's power receiver 7 is mounted at the appropriate position so that receiver aligns with the transmitter when the wheels are touching the block.

In principle, the power receiver 7 can be mounted on either the front or the rear of the vehicle. In reality, the vast majority of drivers find it much easier to drive forward rather than backwards into a parking spot, so power receiver 7 would be mounted slightly ahead of the front wheels in most cases. In special cases, it may be desirable to mount the receiver behind the rear wheels. For example, an emergency vehicle that has to be ready for immediate reaction might mount its power element aft of the rear wheels. However, the better method would be to enclose the power source within a speed bump that can be traversed, as detailed below.

Aside from assisting the driver from aligning the vehicle longitudinally, the fact that the parking block provides an elevated platform for mounting the transmitter is a very important advantage. This reduces the vertical distance between the transmitter and the receiver, and increases the inductive coupling efficiency. In principle, the power transmitter does not have to be housed in the parking block at all. If it were housed a precise distance from the parking block, the alignment would be just as effective as long as the receiver was mounted at the correct location. However, in most vehicles, the space ahead of the front wheels below the bumper is a very convenient location for the power receiver.

It should be clear that any hindrance to longitudinal motion that can be felt by the driver will suffice to serve as an accurate position locator. Instead of parking blocks, a wall that is touched by the vehicle's bumper can be used, Likewise, speed bumps can also be used to house the power transmitter. FIG. 4 shows such an arrangement. The act of traversing a speed bump is precisely felt, and it is just as easy to align a vehicle longitudinally against a speed bump as it is against a parking block. The great advantage of a speed bump is that it can be traversed, which means that they can be used on the sides of streets where vehicles park in a parallel orientation to the street. In FIG. 4, the power receiver 7 is shown as being behind the wheel. This is not really an ideal configuration. It is shown as such in FIG. 4 in order to accentuate the advantage of a speed bump in permitting itself to be traversed. Like the parking block, the speed bump provides an elevated enclosure for the power transmitter.

It should be obvious at this point that any bump on the parking lot surface assists the driver in positioning the vehicle longitudinally. Speed bumps are occasionally formed by digging a small ditch into the road in the manner of a pothole rather than placing a protrusion above the road surface. Placing the power transmitter a certain distance from a depression that can be felt by the driver is an equally effective means of assisting in longitudinal positioning of the vehicle. In most cases, the elevated platform of the parking block or a speed bump will be advantageous, however.

The final dimension for the correct alignment of the receiver to the transmitter is the vertical separation of the two. A number of prior art magnetic power induction schemes have suggested a lifting mechanism for the power receiver. Such a scheme is also appropriate for this invention. FIGS. 5 and 6 show the power receiver in the up and down positions respectively. In the up position, the power receiver is lifted out of the way to provide maximum ground clearance. In the down position, the power receiver can physically contact the surface of the power transmitter for essentially perfect power coupling between the transmitter and the receiver. The great advantage of a lifting mechanism is that the height of the transmitter does not affect the power coupling efficacy. If the power transmitter is below the ground level, the receiver can simply reach down to meet it. If the power transmitter is enclosed in a parking block or a speed bump, the receiver will not have to reach as far.

A swing arm 11 is shown in FIGS. 5 and 6. Obviously, a swing arm is not the only method of raising and lowering the power receiver, and a number of suitable mechanisms are well known to a typical mechanical designer. Linear actuators may save a little bit of space aboard the vehicle in certain cases. In most cases, the raising and lowering operations will be energized by an electrical servo of some kind, or by mechanical lever connections to the driver's compartment. This operation can be connected to the parking brake operation, although it is probably more convenient to actuate the power receiver separately so that the parking brake can be used without lowering the charger.

A swing arm's motion is not confined to the vertical dimension, nor does it need to be. As long as the lowered position of the receiver aligns with the transmitter, the act of extending the receiver does not have to be restricted to any simple motion. For example, aircraft landing gears are often designed with complex motions that traverse all three dimensions, but achieves the correct position and orientation when extended. Likewise, the only important parameter for a suitability of a particular mechanism for this purpose is that the power receiver maintain its proper orientation and position throughout its range of motion. It is desirable to design the actuator so the power receiver could be set at various heights, in order to access power transmitters of differing heights.

FIG. 7 shows a typically preferred embodiment of this invention, with all of the major components in place. The power receiver 7 encloses the load 2, which will almost always include a rectifier, the power receiving coil 6, and the ferrous core element 4. In many installations, there will also be an identity transmitter present within the vehicle to broadcast the vehicle's identity. This transmitter does not have to be housed within the power receiver 7, but it is shown as being housed there for convenience of illustration.

The power transmitter is shown as being housed in a speed bump 9b, with a power supply 1A and a proximity switch 13. The main energy transfer elements are the coil 5 and ferrous core 3. The transmitter is shown as having the vehicle identity interrogator 12. The power transmitter and receiver are shown as being aligned for power transfer. As mentioned already, it is very much desirable to configure the coils as shown in FIG. 7, such that the coils wrap as much surface area of the ferrous cores as possible. The purpose of this configuration is to minimize the “leakage” of the magnetic field and to contain as much energy as possible in the ferrous cores. Toroidal coils are in common use for this purpose, since they minimize magnetic field leakage that can interfere with operations of other components. Thus, when the transmitter and receiver are aligned, the electromagnetic elements should resemble a toroidal coil. This will maximize the coupling of the magnetic field between the transmitter and the receiver, as well as minimize the undesirable leakage of magnetic field and power.

Ferrous cores 3 and 4 are shown as having inwardly extending arms. The purpose of these have been explained already, to provide a greater overlapping cross section between the transmitter and the receiver so as to permit a moderate misalignment laterally with little loss of inductive coupling performance. Of course, transmitter and receiver elements do not have to be of the same size or dimension; they just need to have sufficient overlapping cross sectional area to form an efficient magnetic circuit.

It should be noted that rectifiers typically have at least one transforming coil. Practically, it is extremely unlikely that the required charging voltage of the battery will conveniently coincide with the supply voltage, especially if the electrical power supply is merely the municipal electrical power grid. So, a transforming coil is always needed. Obviously, the electromagnetic components of this invention constitute a transformer separated into two pieces, so the electromagnetic components shown in FIG. 7 should be integral parts of the rectifier design to the extent possible. Note that this and all embodiments of shown in this document are meant to be exemplary rather than exclusive—individuals skilled in electromagnetic inductor design or power transformer designs should be able to derive other layouts based on the teachings of this document.

If these systems are installed in public parking lots, it will become necessary to identify the individual vehicles drawing power out of the power transmitters for billing purposes. Probably the best candidate for this purpose is the “identity chip” that is becoming commercially popular right now. These solid state devices transmit a very low powered coded signal that identifies the vehicle to a specific interrogation device. This technology is very popular for billing of metered commodities, so it should be applicable for the same purpose in the context of this invention. Of course, other technologies like optical recognition are possible as well.

One method of billing vehicles in populated locations would be a self reporting scheme using wireless and cellular communication technologies that are saturating the urban population centers right now. A vehicle can use its global positioning system to identify its own location within a meter, and initiate a wireless call to transmit a charging request to the billing entity that controls that charger over which the vehicle is parked. Such a scheme has the advantage of needing virtually no other components than what is already commonly placed aboard commercially available passenger vehicles. However, the more reliable solution is probably the embedding of an identity chip within the magnetic induction power receiver and an interrogator within the power transmitter as shown in FIG. 7.

Given the fact that parking spaces are always larger than the vehicle's width, and the fact that parking blocks or speed bumps are also wider than the vehicles, it is possible to build in a lateral degree of freedom into such a enclosures. FIGS. 8 and 9 show an arrangement of the electromagnetic components of the power transmitter being mounted on a sliding truck that is free to move along the width of the parking block enclosure 9A. The coil 3 and the ferrous core 5 are mounted on a truck 14, which rides on wheels 15. Obviously, the purpose of the wheels is to confine the motion of the electromagnetic components in every direction other than the direction of intended motion. Thus, they do not necessarily have to be positioned along the bottom, nor do they all have to be co-planar as shown in this diagram.

This type of an enclosure is a hollow shell in order to permit the movement of the electromagnetic components in the lateral direction. This means that if a speed bump enclosure is used, the shell has to be able to support the weight of the entire vehicle. Of course, it is possible to transfer some of the load onto the electromagnetic components in a way that still permits the lateral motion. Sliding bearings that bear loads are well known components. However, it is probably preferable to use parking block enclosures as shown in FIG. 8 and 9, since they do not ever have to bear the weight of the vehicles on them.

The electromagnetic components can be positioned by a linear actuator 16. As before, there is no preference in the specific type of actuator, as long as it pushes and pulls desired distances repeatably. A trivially simple position control feedback algorithm can be used. Since the purpose of aligning is to maximize the amount of power being transferred to the vehicle, the current flowing through the coil 3 can be used as the feedback parameter to be maximized. A commonly available current probe placed around the wire that exits from the power supply 1 is a perfectly suitable sensor in this application. A simple Newton Ralphson algorithm found in any numerical recipe handbook is a suitable control algorithm. The linear actuator can position the truck at a coordinate that maximizes the current flow according to the Newton Ralphson algorithm.

It should be pointed out that if the truck is free to move, merely energizing the coil 3 should produce a magnetic attraction with the power receiver components that will tend to align the electromagnetic power transmission components to the power receiving components. In many cases, simply permitting the truck 14 to move inside a parking block will be a perfectly suitable means of aligning the electromagnetic components.

I claim:

1. A method for aligning a stationary oscillating magnetic field power source and a vehicle-mounted oscillating magnetic field power absorber, comprising:
(a) providing a stationary magnetic inductor means,
(b) providing a vehicle-mounted magnetic inductor means,
(c) providing a physical contact barrier means that hinders the longitudinal motion of the vehicle,
(d) defining a point of barrier contact on the vehicle,
(e) defining a point of vehicle contact on the barrier,
(f) placing said vehicle-mounted magnetic inductor means within the vehicle a first longitudinal distance away from said point of barrier contact, and
(g) placing said stationary magnetic inductor means outside of the vehicle a second longitudinal distance away from the said point of vehicle contact on the barrier, said second longitudinal distance being substantially similar to said first longitudinal distance,
whereby a substantial longitudinal alignment between said stationary magnetic inductor means and said vehicle-mounted magnetic inductor means is achieved when the vehicle touches said barrier means, and electromagnetic energy can be transferred from said stationary magnetic inductor means to said vehicle-mounted magnetic inductor means.

2. The method of claim 1 wherein said physical contact barrier means is selected from the group consisting of a wall means, a parking block means, and a speed bump means.

3. The method of claim 1 wherein said stationary magnetic inductor means is enclosed within said physical contact barrier means.

4. The method of claim 3 wherein said magnetic inductor means is slidably mounted within said physical contact barrier means.

5. A system for transferring electrical energy from a stationary alternating current source to a stationary road-vehicle, comprising:
(a) a stationary magnetic inductor means,
(b) electrical wire means connecting said stationary alternating current source and said stationary magnetic inductor means,
(c) a vehicle-mounted magnetic inductor means,
(d) electrical wire means connecting said vehicle-mounted magnetic inductor means to the other electrical apparatus of the road-vehicle,
(e) a stationary physical contact barrier means that hinders normal longitudinal motion of the road-vehicle,
(f) a point of barrier contact being defined on the vehicle,
(g) a point of vehicle contact being defined on the barrier,
(h) said vehicle-mounted magnetic inductor means being mounted a first longitudinal distance away from said point of barrier contact on the vehicle,
(h) said stationary magnetic inductor means being mounted said a second longitudinal distance away from said point of vehicle contact on the barrier means, said second longitudinal distance being substantially similar to said first longitudinal distance,
whereby a substantial longitudinal alignment between said stationary magnetic inductor means and said vehicle-mounted magnetic inductor means is achieved when the vehicle touches the barrier in normal longitudinal motion, and electrical energy can be transferred from said stationary source to the vehicle in form of oscillating magnetic field.

6. The system of claim 5, further including an actuator means for said vehicle-mounted magnetic inductor means, whereby the magnetic inductor can be raised or lowered as desired.

7. The system of claim 5, wherein said stationary magnetic inductor means is enclosed within said stationary physical contact barrier means.

8. The system of claim 5, wherein said stationary physical contact barrier means is selected from the group consisting of wall means, speed bump means, and parking block means.

9. The system of claim 8, wherein said stationary magnetic inductor means is enclosed within said stationary physical contact barrier means.

10. The system of claim 9, wherein said stationary magnetic inductor means is laterally slidably mounted.

11. The system of claim 5, wherein said stationary magnetic inductor means is laterally slidably mounted.
